(19) United States
(12) Patent Application Publication
(10) Pub. No.: US 2024/0148470 A1
(43) Pub. Date: May 9, 2024

(54) PARALLEL AND ANGLED DENTAL IMPLANT PLACEMENT GUIDE

(71) Applicants: Hunter Chase Fleenor, Spring Hill, TN (US); Malcolm Lamar Shealer, Nolensville, TN (US)

(72) Inventors: Hunter Chase Fleenor, Spring Hill, TN (US); Malcolm Lamar Shealer, Nolensville, TN (US)

(21) Appl. No.: 18/497,158

(22) Filed: Oct. 30, 2023

Related U.S. Application Data
(60) Provisional application No. 63/422,045, filed on Nov. 3, 2022.

(51) Int. Cl. A61C 1/08

(52) U.S. Cl. CPC A61C 1/084

(57) ABSTRACT

A guide for placement of a dental implant. The guide may comprise a guide pin sleeve, a drill guide sleeve, and a frame structure. The guide pin sleeve may be configured to be inserted over a parallel guide pin. The drill guide sleeve may be configured to receive at least a portion of a drill. The frame structure may be configured to couple the drill guide sleeve to the guide pin sleeve at a particular distance from the guide pin sleeve and at a particular angle with respect to the drill guide sleeve.

This application claims priority to U.S. application No. 63/422,045, filed Nov. 3, 2022, Titled Parallel and Angled Dental Implant Placement Guide, the contents of which are incorporated herein by reference in its entirety.

### BACKGROUND

Implants in modern dentistry started as early as 1965, when Dr. Branemark placed the first successful implant on a live patient. Since 1965 dental implants have been vastly improved and have become the standard of care for replacing missing or failing teeth. These improvements have helped dental implants adhere or integrate into the bone thus giving a stable platform to replace missing teeth.

### SUMMARY

In some implementations, a guide for placement of a dental implant may comprise a guide pin sleeve configured to be inserted over a parallel guide pin; a drill guide sleeve configured to receive at least a portion of a drill; and a frame structure configured to couple the drill guide sleeve to the guide pin sleeve at a particular distance from the guide pin sleeve and at a particular angle with respect to the drill guide sleeve.

In some implementations, the guide pin sleeve may comprise a drain hole configured to enable a user to view the parallel guide pin when guide pin sleeve is inserted over the parallel guide pin.

In some implementations, a bottom surface of the guide pin sleeve may be configured to rest on a top surface of a dental implant.

In some implementations, the drill guide sleeve may comprise one or more drain holes configured to allow a fluid or a bone to drain from the drill guide sleeve.

In some implementations, the drill guide sleeve may comprise a drill guide hole.

In some implementations, the drill guide hole may be configured to receive at least a portion of a tissue punch.

In some implementations, the frame structure may comprise a stabilization brace.

In some implementations, the frame structure may comprise three stabilization braces.

In some implementations, the frame structure is configured to prevent a rotation of the guide during an initial osteotomy.

In some implementations, a guide system may comprise a first guide and a second guide. The first guide may comprise a first guide pin sleeve configured to be inserted over a parallel guide pin, a first drill guide sleeve configured to receive at least a portion of a drill, and a first frame structure configured to couple the first drill guide sleeve to the first guide pin sleeve at a first distance from the first guide pin sleeve and at a first angle with respect to the first drill guide sleeve. The second guide may comprise a second guide pin sleeve configured to be inserted over the parallel guide pin, a second drill guide sleeve configured to receive at least the portion of the drill, and a second frame structure configured to couple the second drill guide sleeve to the second guide pin sleeve at a second distance from the second guide pin sleeve and at a second angle with respect to the second drill guide sleeve.

In some implementations, the first distance may be different from the second distance.

In some implementations, the first angle may be different from the second angle.

In some implementations, the first angle may comprise 0 degrees, 15 degrees, 17 degrees, 30 degrees, or 45 degrees.

In some implementations, the first distance may be the same as the second distance, and the first angle may be different from the second angle.

In some implementations, the first distance may be different from the second distance, and the first angle may be the same as the second angle.

In some implementations, the first angle may comprise 0 degrees, 15 degrees, 17 degrees, 30 degrees, or 45 degrees.

In some implementations, the guide system may further comprise a plurality of guides having respective lengths. The plurality of guides may include the first guide, the second guide, and at least one additional guide.

In some implementations, the respective lengths of the plurality of guides may range from 10 mm to 25 mm.

In some implementations, the respective lengths increase in one or more increments.

In some implementations, the one or more increments comprise one or more of a 0.5 mm increment, a 1.0 mm increment, or a 1.5 mm increment.

### BRIEF DESCRIPTION OF THE DRAWINGS

FIG. 1 is a diagram of a parallel angulation guide according to an implementation described herein.

FIGS. 2A-2C are diagrams of a 15-degree angulation guide angulation guide according to an implementation described herein.

FIGS. 3A-3C are diagrams of a 17-degree angulation guide angulation guide according to an implementation described herein.

FIGS. 4A-4C are diagrams of a 30-degree angulation guide angulation guide according to an implementation described herein.

FIGS. 5A-5C are diagrams of a 45-degree angulation guide angulation guide according to an implementation described herein.

FIG. 6 is a diagram of a parallel uncover guide system according to an implementation described herein.

FIGS. 7A and 7B are diagrams of a parallel angulation guide with example dental implants according to an implementation described herein.

FIGS. 8A-8F are diagrams depicting a method of utilizing a guide system according to an implementation described herein.

### DETAILED DESCRIPTION

The following detailed description of example implementations refers to the accompanying drawings. The same reference numbers in different drawings may identify the same or similar elements.

A tooth is comprised of three main structures the crown of the tooth, the neck of the tooth (also referred to as the cemento-enamel junction), and the root of the tooth. The crown of the tooth comprises a portion of the tooth that is located above the gum tissue. The neck of the tooth comprises the portion of the tooth where the crown meets the root of the tooth. The bone that surrounds the root surfaces of the tooth is known as the alveolar process. Within this bone there are two types of bone: cortical bone and cancellous bone. The cortical bone is a very dense, hard bone while the cancellous bone is a soft spongy bone interspersed between the bone marrow.

In some cases, a patient may be missing one or more teeth. For example, a patient may be missing a tooth due to the tooth being extracted by a dental professional, an accident or trauma causing the tooth to be forcibly removed from the mouth of a patient, and/or the like. A dental implant may be used to restore (e.g., replace) the missing tooth/teeth. A type of dental implant may depend on a quantity of teeth being restored. For example, a dental implant bridge may be used to restore one or more missing teeth. The dental implant bridge may comprise one or more dental implants. Each dental implant may comprise a dental implant body, an abutment, and a crown. The dental implant body may comprise a portion of the dental implant that is inserted into the cortical bone of the patient. The abutment may comprise a portion of the dental implant that is attached to the dental implant body with a screw. The crown may comprise a portion of the dental implant that is attached to the abutment (e.g., utilizing a cement) or screwed into the dental implant body.

To restore all of the teeth of a patient, an overdenture, also called a snap in denture, or a fixed denture may be used. An overdenture consists of four or more dental implants on the upper (maxillary) arch and two or more dental implants on the lower (mandibular) arch. These dental implants may comprise a dental implant body and a locator abutment. The locator abutment may be configured to retain the denture. For example, the locator abutment may be shaped to be received by and/or snapped into the denture to help retain the denture within the mouth of the patient. To achieve a good result on an overdenture, each of the dental implants should be placed parallel to each of the other dental implants.

A fixed denture consists of four or more dental implants on the upper (maxillary) arch and a minimum of three dental implants on the lower (mandibular) arch. With a fixed denture the dental implants can be angled more than with an overdenture with the use of multi-unit abutments which are screwed into the dental implant. These multi-unit abutments help overcome the angulation with varying degrees of correction and then are the platform for the final prosthesis to be secured in place. Proper planning of implant placement and angulation helps achieve a successful prosthesis.

Both the cortical bone and the cancellous bone are necessary for proper integration of a dental implant into the mouth of a patient. When placing a dental implant there are two stages of integration into the bone surrounding the root surfaces of a patient. The first stage is primary integration stage. The primary integration stage may comprise the initial placement of a dental implant in the cortical bone. The denseness and hardness of the cortical bone may provide a primary stability for the dental implant. The second stage of integration may comprise a response to the implant by the cancellous bone. In response to the dental implant being inserted into the cortical bone, the cancellous bone may cause bone to be formed around the dental implant. The bone formed around the dental implant may provide a secondary stability to the dental implant. Both primary and secondary stability are needed for predictable long-term success for dental implants. To achieve successful dental implant placement, precise measurements are needed pre-surgically to ensure appropriate execution of implant placement.

In some cases, a surgical guide may be required or desired by the clinician placing the implants. Surgical guides help the clinician attain a more predictable outcome of where the implant is placed. True “surgical guides” are comprised of a guiding cylinder and a contact surface which can be adhered to a patient's existing teeth, bone, or soft tissue. These guides require an impression of the patient's existing teeth and soft tissue and/or a three-dimensional (3D) image of the patient's existing teeth and soft tissue (e.g., a 3D image generated using an intraoral scanner and a 3D x-ray (CBCT—Cone-beam computed tomography systems)). These impression and/or the 3D image of the patient's existing teeth and soft tissue are then used to create a surgical guide that fits the patient's anatomy. In some cases, the surgical guide is made of 3D printed resin and sterilized. While fabrication of these guides has improved, the guides must be created for each patient and, because they are created fit to each patient individually, a single guide cannot be used for multiple, different patients.

Some guides are configured to use an initial osteotomy of the alveolar bone to guide the next implant. When placing a dental implant, the initial osteotomy of the alveolar bone is done using a pilot drill. However, a problem arises to using the initial osteotomy when placing multiple implants during an immediate extraction and implant placement. When a tooth is extracted, a hole (or socket) the size of the root surface is left in the alveolar bone that is larger than the initial pilot drill size. But this socket can be used directly or modified to place an implant. Depending on what size of implant is used a sequence of drills are used to widen the bone. Once the bone is prepped to the clinician's desired width, the dental implant is inserted into the bone.

In some cases, a dental implant may be placed “free hand” or without the use of a surgical guide. Traditional free hand approach to placing subsequent dental implants once an initial dental implant is placed is to attach a paralleling pin to the initial dental implant to help with angulation of the second dental implant. The paralleling guide pin is screwed into the first implant and then the clinician would place the pilot drill next to it to gauge the proper angulation and proceed with prepping the next site for implant. The process is then repeated for each subsequent dental implant.

Some implementations described herein are related to a guide system configured to ensure the uniform placement of sequential dental implants when placing multiple dental implants for restoring lost or missing teeth. For example, the guide system may include a set of guides for positioning a set of dental implants in a uniform manner (e.g., at a same distance from an adjacent dental implant and/or at a same angle). Each guide having a first hollow leg (also referred to herein as a “pin sleeve”) configured to slide over a paralleling pin and a second hollow leg (also referred to herein as a “drill sleeve”) configured to receive a portion of a drill for drilling into the bone of a patient. A frame portion may extend between the pin leg and the drill guide. Each frame portion of each guide may be configured to a set length. In some implementations, a length of a frame portion of a first guide is the same as a length of a frame portion of one or more other guides. In some implementations, the length of the frame portion of the first guide is different from a length of a frame portion of one or more other guides. In some implementations, the length of each frame portion of each guide may be the same. In some implementations, the length of each frame portion of each guide may be different.

In some implementations, the drill guide of each guide may extend at a range of angulations. For example, the drill guide of a first guide may be configured to be parallel, 15°, 17°, 30°, 45°, and/or another angle. In some implementations, an angulation of the guide coincides with the prosthetic design and bone availability when placing implants. In some implementations, the guide may comprise a 15° angulation guide for overdenture snap in 15° abutments. In some implementations, the guide may comprise a 15°, 17°, 30°, or 45° angulation and may be configured to be used for fixed denture cases.

The guide system combines both freehand implant and guided implant placement and is re-usable on multiple patients. The use of the paralleling pin instead of an initial osteotomy pilot drill guide provides a more stable base to place the guide, as well as the ability to use the guide in previous extraction sites where an initial osteotomy guide would not work.

The guide system expands upon the free hand implant placement approach by providing an aid to sequential implant placement, as sequential implant replacement may require one implant to be placed before the guides are to be used. The use of the guide helps speed up placement of sequential implants. For example, a guide can be selected based on the a desired spacing between the dental implants and/or the desired angulation. As the guide is already at the predetermined length, the guide may eliminate the need to measure the distance from one implant site to the next and the drill leg enables the dental implant to be set at the desired angulation.

The guide system is designed to be reused. In some implementations, the guide may comprise a surgical guide resin that is 3D printed using a 3D printer. The surgical guide resin can be sterilized using a steam autoclave. In some implementations, the guide may be comprised of surgical stainless steel.

The guide system can be used on multiple people due to its design. In some implementations, the guide system may comprise a set of guides having set lengths and angulations to allow for guided implant placement thereby allowing the guide system to be used for multiple different patients rather than having to use a guide having a length and angulation chosen for a particular patient (e.g., rather than custom making a guide for each patient).

In some implementations, the guide comprises a dental implant surgical instrument that is configured to enable the uniform placement (e.g., at a uniform distance and/or a uniform angle) of a dental implant. In these implementations, the guide may comprise a surgical guide resin. Additionally, or alternatively, the guide may comprise a different material, such as, for example, surgical steel and/or a material that is more hardened relative to surgical guide resin. In some implementations, the guide system may be configured to be utilized for full mouth implant surgery (over—denture, All on 4, All on X, and/or all on 6) to implant bridge surgery. The guide system can be used to place implants at a wide array of angulations and spreads. In some implementations, the guide system may comprise a guide having a length within a range from about 10 mm to about 25 mm.

In some implementations, the guide system may comprise a plurality of guides. For example, the guide system may comprise a plurality of guides having respective lengths with a range from about 10 mm to about 25 mm. In some implementations, the respective lengths of the plurality of guides may increase incrementally. For example, the respective lengths may increase in 0.5 mm increments, 1 mm increments, 1.5 mm increments, and/or the like.

In some implementations, the plurality of guides may have respective angulations of parallel, 15°, 17°, 30°, 45°. Additionally, or alternatively, one or more guides, of the plurality of guides may have a different and/or additional angulation.

In some implementations, the guide system may comprise a guide that will help after the implants have healed to uncover the implant by using a wider drill guide designed for a tissue punch.

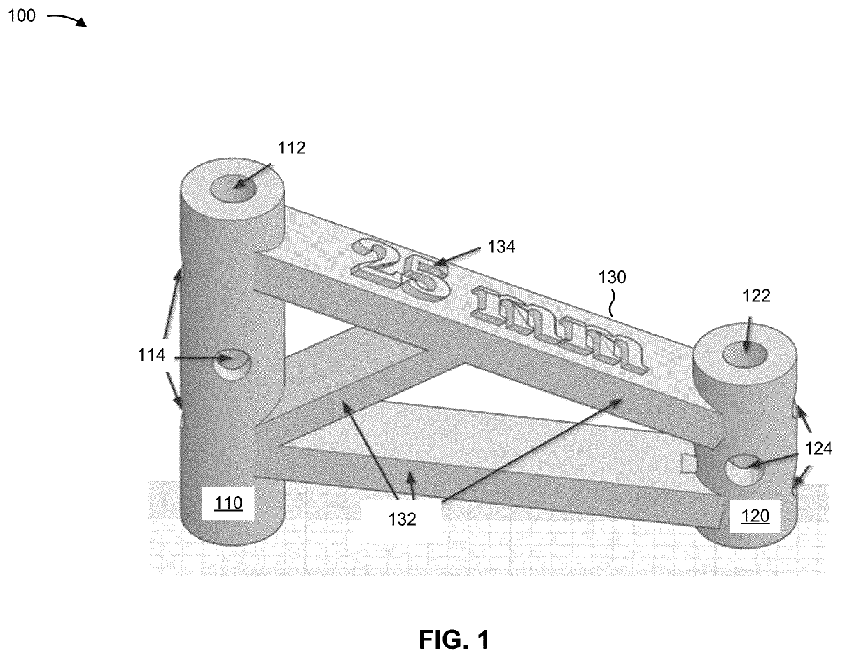

FIG. 1 is a diagram of a parallel angulation guide 100 according to one or more embodiments described herein. As shown in FIG. 1, the parallel angulation guide 100 may comprise a parallel guide pin sleeve 110, a parallel drill guide sleeve 120, and a frame structure 130.

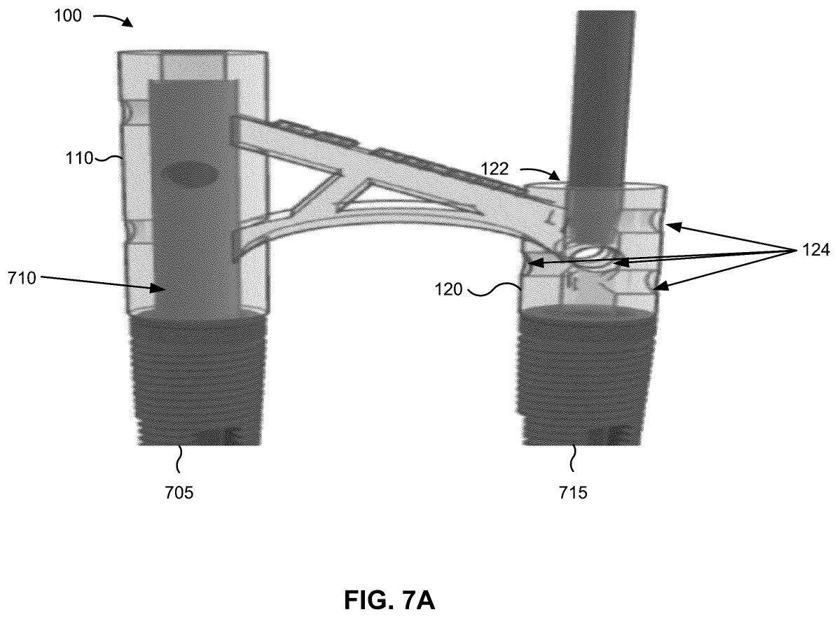

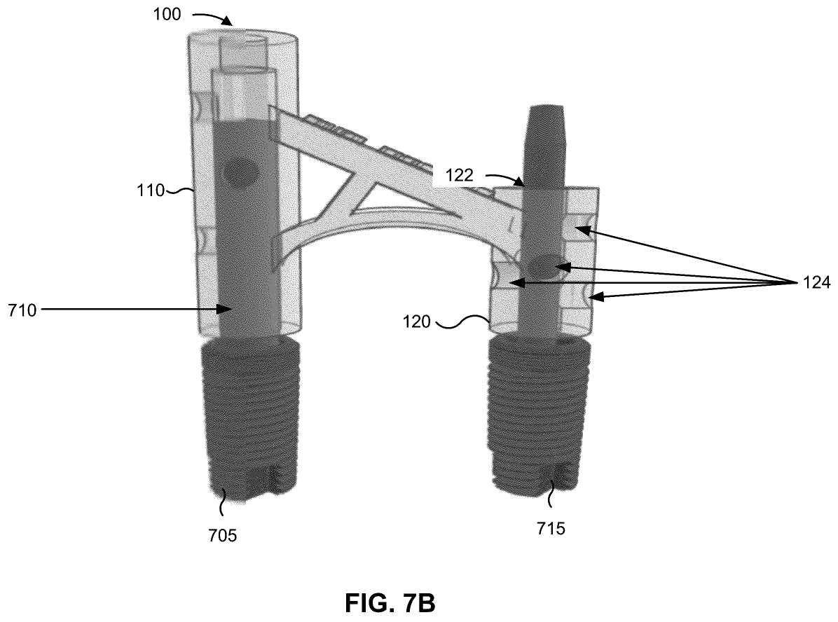

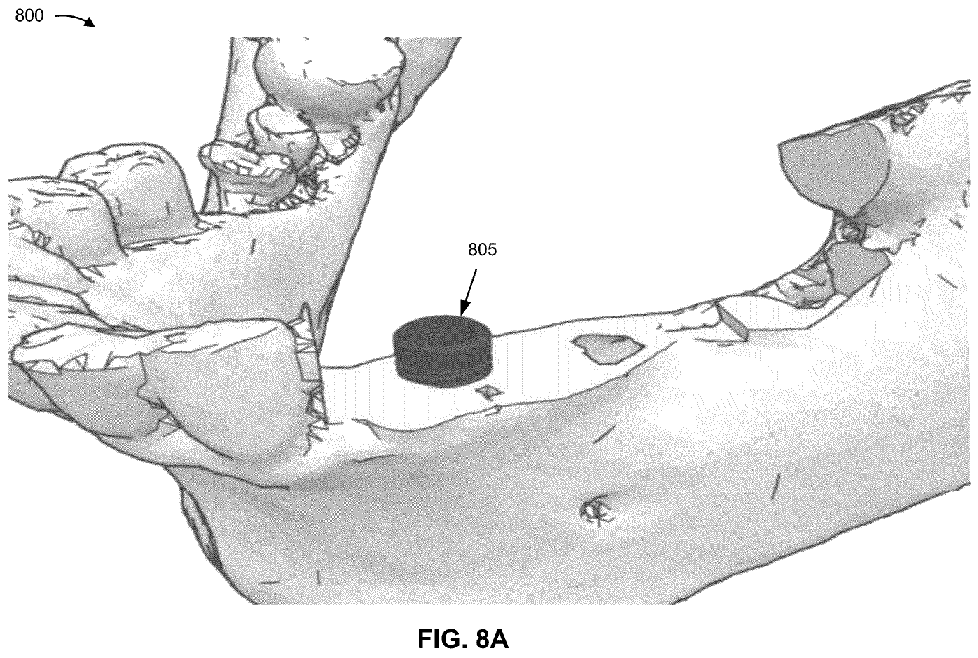

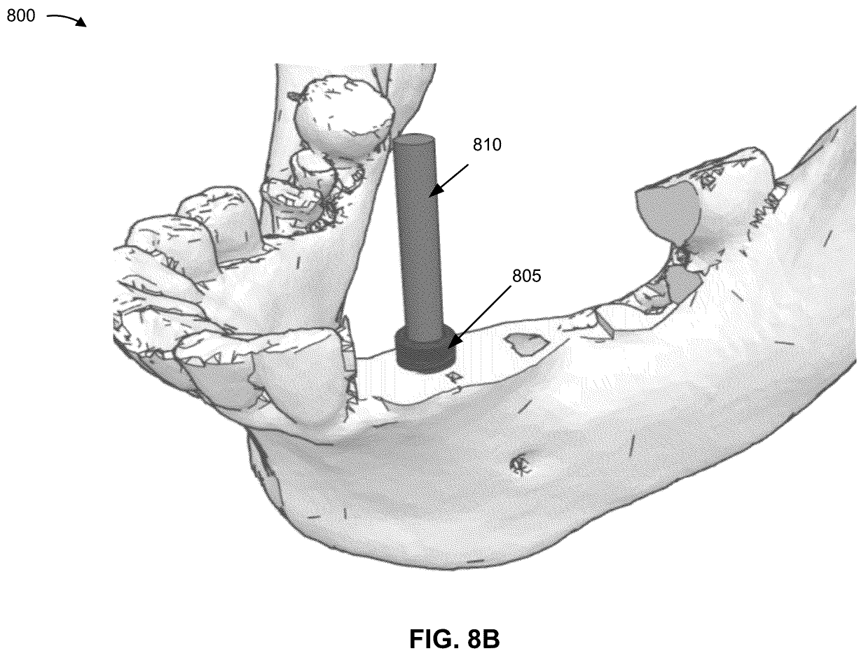

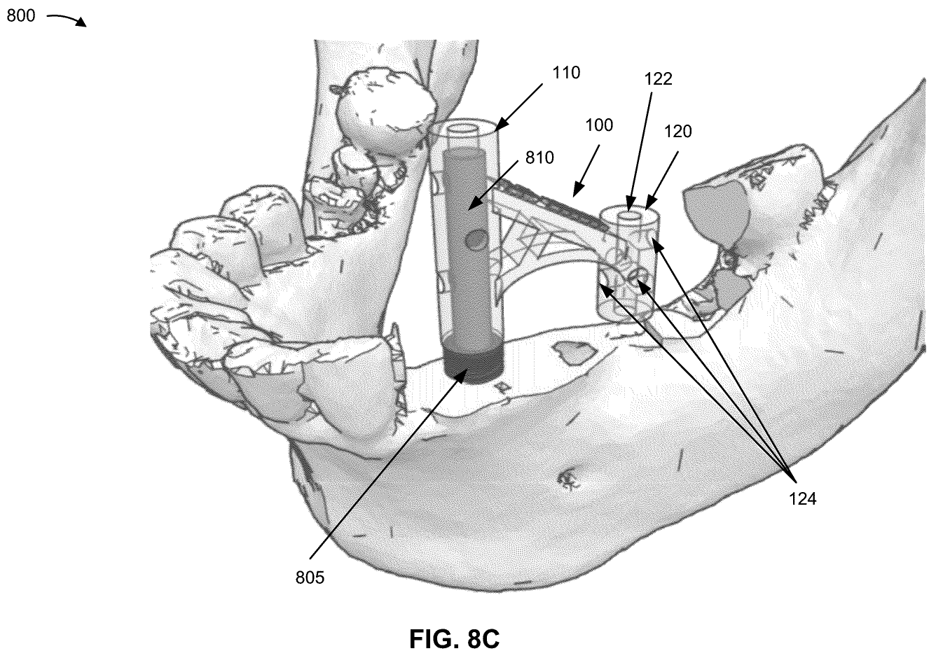

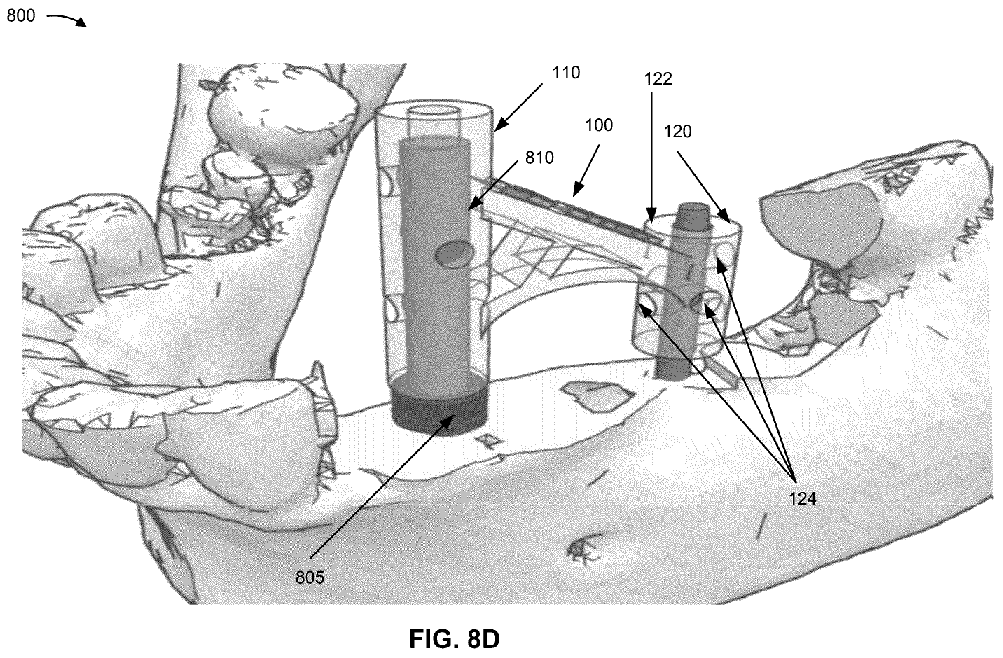

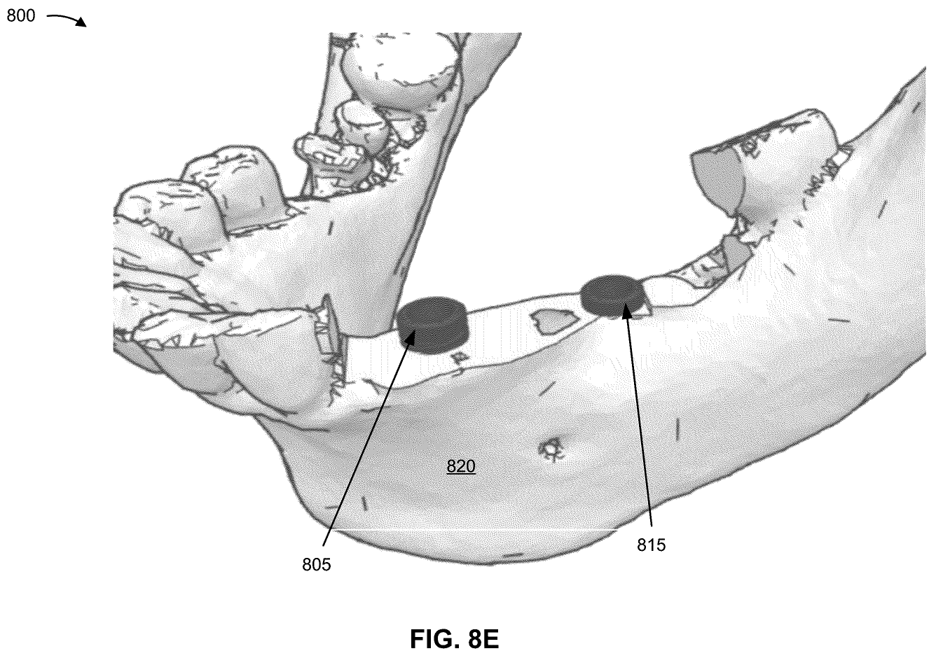

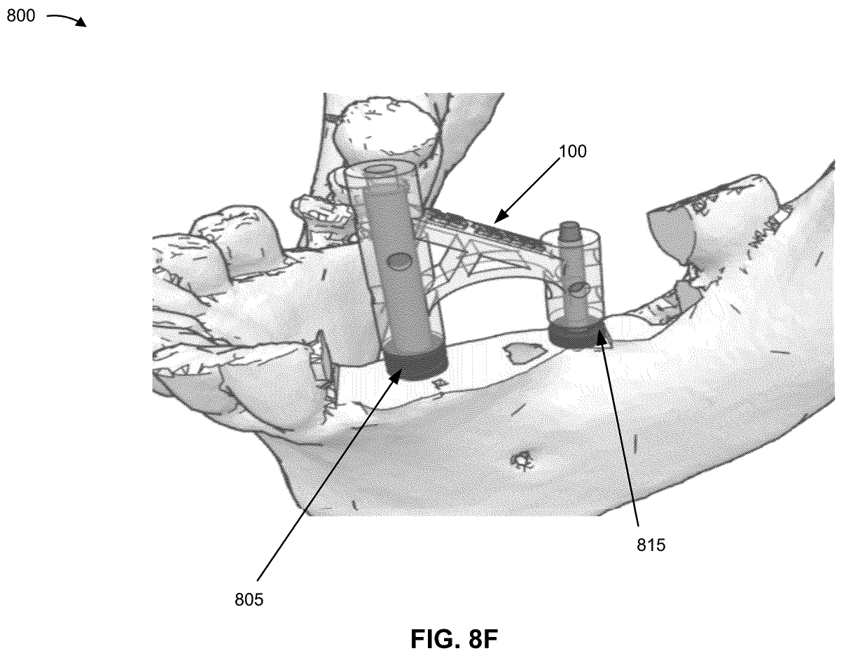

The parallel guide pin sleeve 110 may comprise structure having a shape that is configured to receive at least a portion of a parallel guide pin (e.g., parallel guide pin 710 shown in FIG. 7A). For example, as shown in FIG. 1, the parallel pin sleeve 110 may comprise a hollow cylinder forming a hole 112 that is configured to slide over the top of a parallel guide pin. In some implementations, a bottom surface of the parallel pin sleeve 110 is configured to rest on a top surface of a dental implant, as shown in FIG. 8C.

In some implementations, the parallel guide pin sleeve 110 may comprise a resin drain hole 114. to allow for the resin to drain when printing. In some implementations, as shown in FIG. 1, the parallel guide pin sleeve 110 may comprise a plurality of resin drain holes 114. In some implementations, one or more of the plurality of resin drain holes 114 may be configured to allow for visualization of the parallel guide pin.

The parallel drill guide sleeve 120 may comprise a structure having a shape that is configured to receive at least a portion of drill (e.g., a drill bit). For example, as shown in FIG. 1, the parallel drill guide sleeve 120 may comprise a hollow cylinder forming a drill guide hole 122. In some implementations, the drill guide hole 122 may be configured to receive the 1st and 2nd drills up to 2.0 mm for initial implant osteotomy. In some implementations, the drill guide hole 122 may be configured to accommodate a full guided case. In these implementations, a size of the parallel drill guide sleeve 120 may be configured to receive drills greater than 2.0 mm.

In some implementations, the parallel drill guide sleeve 120 may be configured to receive one or more other tools. For example, the parallel drill guide sleeve 120 may be configured to receive a tissue punch used for uncovering a dental implant after healing.

In some implementations, the parallel drill guide sleeve 120 may include a resin drain hole 124. In some implementations, as shown in FIG. 1, the parallel drill guide sleeve 120 may include a plurality of resin drill holes 124. In some implementations, the parallel angulation guide 100 may be generated using a 3D printing process and the resin drill hole(s) 124 may be configured to allow the resin to drain during the printing process. Additionally, or alternatively, the resin drain hole(s) 124 may be configured to allow water, blood, bone, and/or the like to drain during the initial osteotomy.

The frame structure 130 may be configured to couple the parallel guide pin sleeve 110 parallel to the parallel drill guide sleeve 120 and at a particular distance. In some implementations, the frame structure 130 may include one or more stabilization braces 132. In some implementations, as shown in FIG. 1, the frame structure 130 includes three stabilization braces 132. The use of three stabilization braces 132 may minimize or eliminate a rotation of the parallel drill guide sleeve 120.

In some implementations, the frame structure 130 may include one or more identifiers 134. For example, the frame structure 130 may include an identifier 134 located on a surface of one or more stabilization braces 132. In some implementations, the frame structure 130 may include an identifier 134 indicating a length at which the parallel angulation guide 100 is configured to position a subsequent dental implant (e.g., 25 mm, as shown in FIG. 1), an angle at which the parallel angulation guide 100 is configured (e.g., parallel), and/or the like.

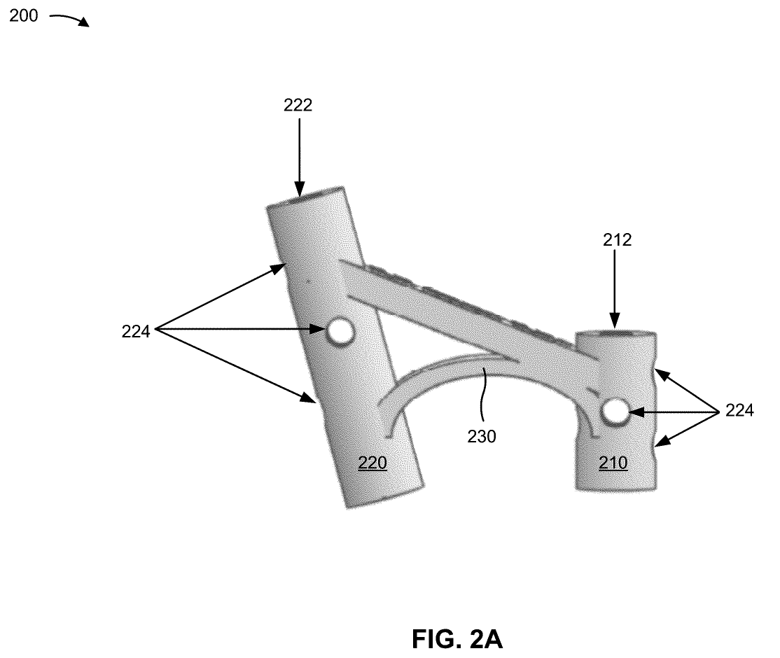

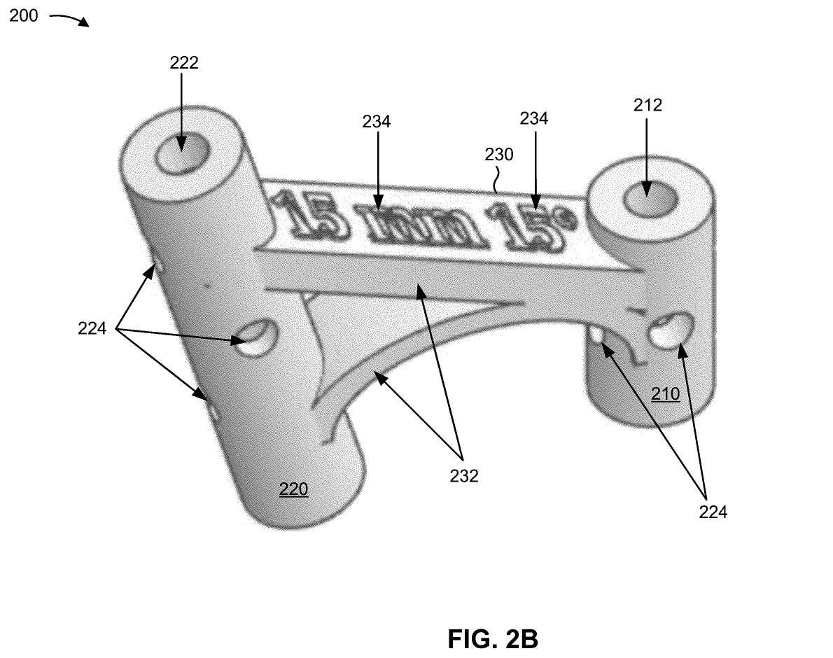

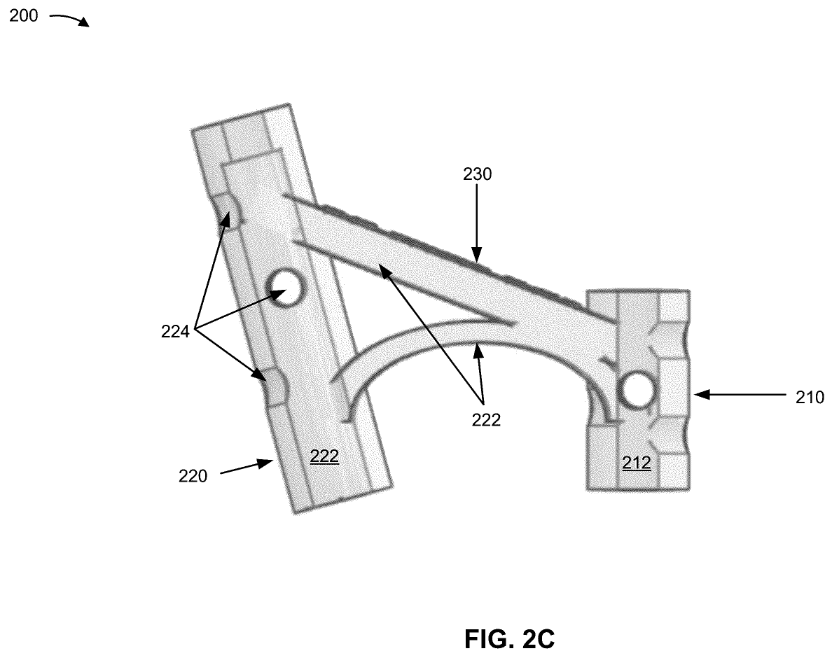

FIGS. 2A-2C are diagrams of a 15-degree angulation guide 200 according to one or more embodiments described herein. As shown in FIGS. 2A-2C, the 15-degree angulation guide 200 may comprise a guide pin sleeve 210, a drill guide sleeve 220, and a frame structure 230.

The guide pin sleeve 210 may comprise structure having a shape that is configured to receive at least a portion of a parallel guide pin (e.g., parallel guide pin 710 shown in FIG. 7A). For example, as shown in FIGS. 2A-2C, the parallel pin sleeve 210 may comprise a hollow cylinder forming a hole 212 that is configured to slide over the top of a parallel guide pin. In some implementations, a bottom surface of the pin sleeve 210 is configured to rest on a top surface of a dental implant, as shown in FIG. 8C.

In some implementations, the guide pin sleeve 210 may comprise a resin drain hole 214. In some implementations, as shown in FIGS. 2A-2C, the guide pin sleeve 210 may include a plurality of resin drill holes 214. In some implementations, the 15-degree angulation guide 200 may be generated using a 3D printing process and the resin drill hole(s) 214 may be configured to allow the resin to drain during the printing process. In some implementations, one or more of the plurality of resin drain holes 214 may be configured to allow for visualization of the parallel guide pin.

The drill guide sleeve 220 may comprise a structure having a shape that is configured to receive at least a portion of drill (e.g., a drill bit). For example, as shown in FIGS. 2A-2C, the drill guide sleeve 220 may comprise a hollow cylinder forming a drill guide hole 222. In some implementations, the drill guide hole 222 may be configured to receive the 1st and 2nd drills up to 2.0 mm for initial implant osteotomy. In some implementations, the drill guide hole 222 may be configured to accommodate a full guided case. In these implementations, a size of the drill guide sleeve 220 may be configured to receive drills greater than 2.0 mm.

In some implementations, the drill guide sleeve 220 may be configured to receive one or more other tools. For example, the drill guide sleeve 220 may be configured to receive a tissue punch used for uncovering a dental implant after healing.

In some implementations, a length of the drill guide sleeve 220 may be the same as a length of the guide pin sleeve 210. In some implementations, the length of the drill guide sleeve 220 may be different from the length of the guide pin sleeve 210. For example, the drill guide sleeve 220 may be longer or shorter than the guide pin sleeve 210.

In some implementations, the drill guide sleeve 220 may include a resin drain hole 224. In some implementations, as shown in FIGS. 2A-2C, the drill guide sleeve 220 may include a plurality of resin drill holes 224. In some implementations, the 15-degree angulation guide 200 may be generated using a 3D printing process and the resin drill hole(s) 224 may be configured to allow the resin to drain during the printing process. Additionally, or alternatively, the resin drain hole(s) 224 may be configured to allow water, blood, bone, and/or the like to drain during the initial osteotomy.

The frame structure 230 may be configured to couple drill guide sleeve 220 at a 15-degree angle with respect to the guide pin sleeve 210 and at a particular distance from the guide pin sleeve 210. In some implementations, the frame structure 230 may include one or more stabilization braces 232. In some implementations, as shown in FIGS. 2A-2C, the frame structure 230 includes two stabilization braces 232.

In some implementations, the frame structure 230 may include one or more identifiers 234. For example, the frame structure 230 may include an identifier 234 located on a surface of one or more stabilization braces 232. In some implementations, the frame structure 230 may include an identifier 234 indicating a length at which the 15-degree angulation guide 200 is configured to position a subsequent dental implant (e.g., 15 mm, as shown in FIG. 2B), an angle at which the 15-degree angulation guide 200 is configured (e.g., 15 degrees, as shown in FIG. 2B), and/or the like.

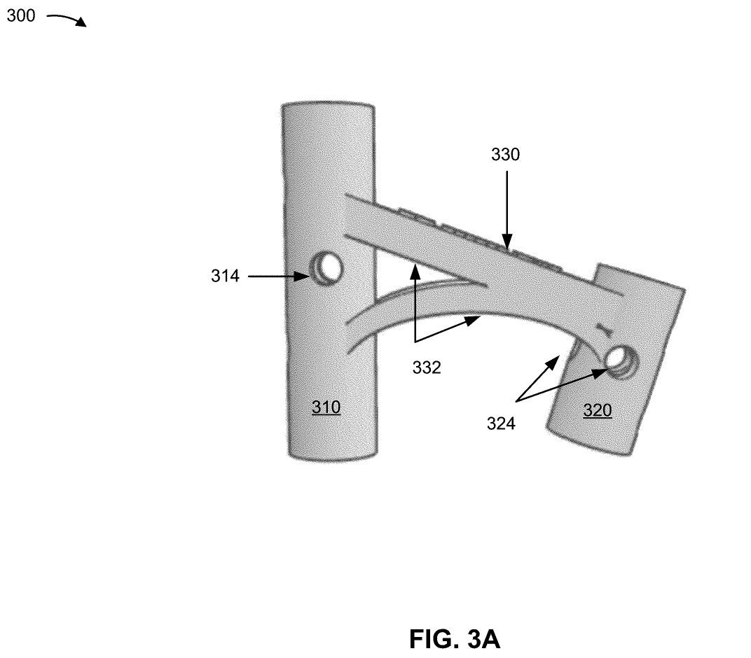

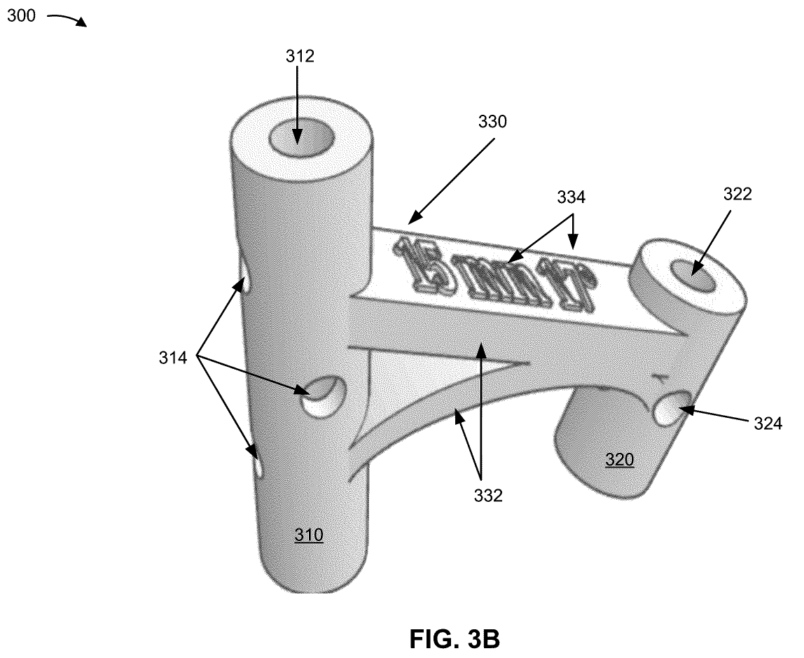

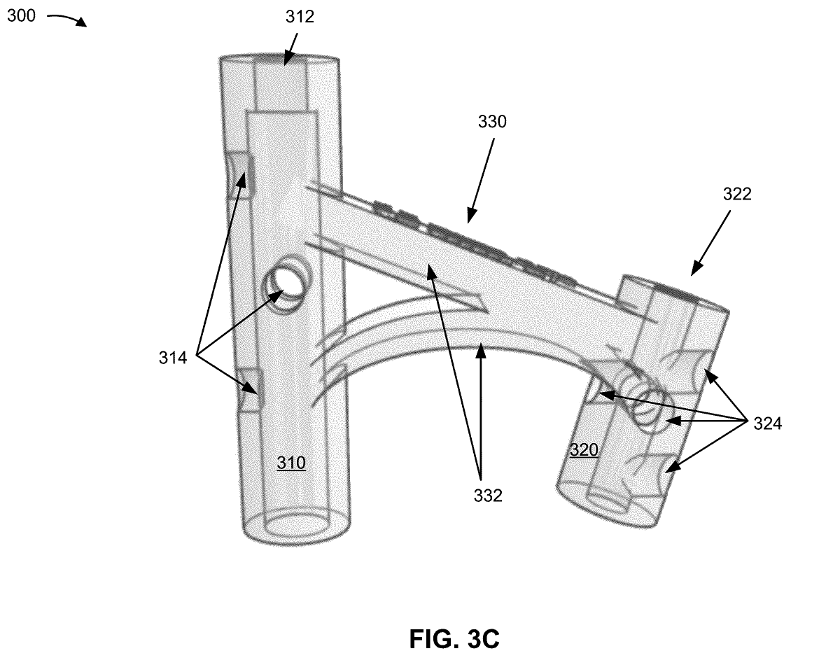

FIGS. 3A-3C are diagrams of a 17-degree angulation guide 300 according to one or more embodiments described herein. As shown in FIGS. 3A-3C, the 17-degree angulation guide 300 may comprise a guide pin sleeve 310, a drill guide sleeve 320, and a frame structure 330.

The guide pin sleeve 310 may comprise structure having a shape that is configured to receive at least a portion of a parallel guide pin (e.g., parallel guide pin 710 shown in FIG. 7A). For example, as shown in FIGS. 3A-3C, the parallel pin sleeve 310 may comprise a hollow cylinder forming a hole 312 that is configured to slide over the top of a parallel guide pin. In some implementations, a bottom surface of the pin sleeve 310 is configured to rest on a top surface of a dental implant, as shown in FIG. 8C.

In some implementations, the guide pin sleeve 310 may comprise a resin drain hole 314. In some implementations, as shown in FIGS. 3A-3C, the guide pin sleeve 310 may include a plurality of resin drill holes 314. In some implementations, the 17-degree angulation guide 300 may be generated using a 3D printing process and the resin drill hole(s) 314 may be configured to allow the resin to drain during the printing process. In some implementations, one or more of the plurality of resin drain holes 314 may be configured to allow for visualization of the parallel guide pin.

The drill guide sleeve 320 may comprise a structure having a shape that is configured to receive at least a portion of drill (e.g., a drill bit). For example, as shown in FIGS. 3A-3C, the drill guide sleeve 320 may comprise a hollow cylinder forming a drill guide hole 322. In some implementations, the drill guide hole 322 may be configured to receive the 1st and 2nd drills up to 2.0 mm for initial implant osteotomy. In some implementations, the drill guide hole 322 may be configured to accommodate a full guided case. In these implementations, a size of the drill guide sleeve 320 may be configured to receive drills greater than 2.0 mm.

In some implementations, the drill guide sleeve 320 may be configured to receive one or more other tools. For example, the drill guide sleeve 320 may be configured to receive a tissue punch used for uncovering a dental implant after healing.

In some implementations, a length of the drill guide sleeve 320 may be the same as a length of the guide pin sleeve 310. In some implementations, the length of the drill guide sleeve 320 may be different from the length of the guide pin sleeve 310. For example, the drill guide sleeve 320 may be longer or shorter than the guide pin sleeve 310.

In some implementations, the drill guide sleeve 320 may include a resin drain hole 324. In some implementations, as shown in FIGS. 3A-3C, the drill guide sleeve 320 may include a plurality of resin drill holes 324. In some implementations, the 17-degree angulation guide 300 may be generated using a 3D printing process and the resin drill hole(s) 324 may be configured to allow the resin to drain during the printing process. Additionally, or alternatively, the resin drain hole(s) 324 may be configured to allow water, blood, bone, and/or the like to drain during the initial osteotomy.

The frame structure 330 may be configured to couple drill guide sleeve 320 at a 17-degree angle with respect to the guide pin sleeve 310 and at a particular distance from the guide pin sleeve 310. In some implementations, the frame structure 330 may include one or more stabilization braces 332. In some implementations, as shown in FIGS. 3A-3C, the frame structure 330 includes two stabilization braces 332.

In some implementations, the frame structure 330 may include one or more identifiers 334. For example, the frame structure 330 may include an identifier 334 located on a surface of one or more stabilization braces 332. In some implementations, the frame structure 330 may include an identifier 334 indicating a length at which the 17-degree angulation guide 300 is configured to position a subsequent dental implant (e.g., 15 mm, as shown in FIG. 3B), an angle at which the 17-degree angulation guide 300 is configured (e.g., 17 degrees, as shown in FIG. 3B), and/or the like.

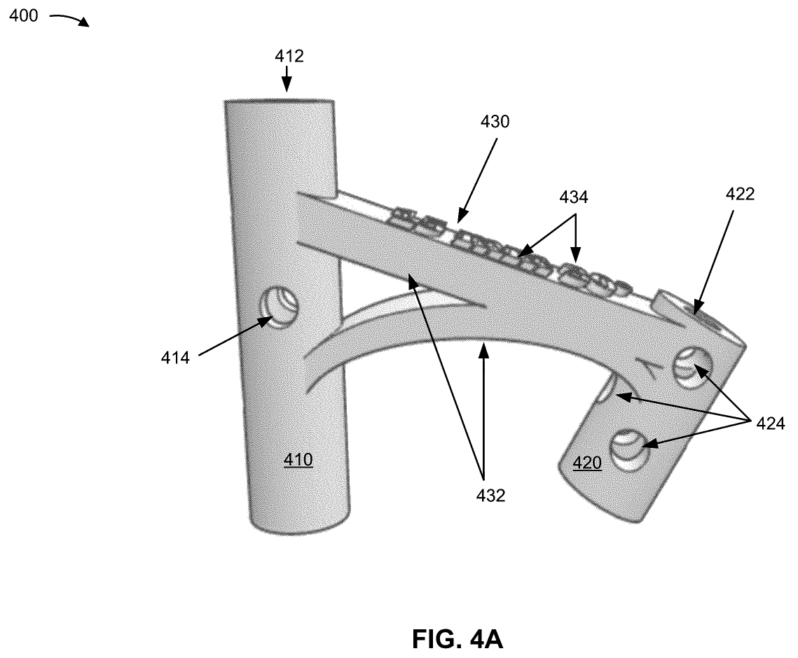

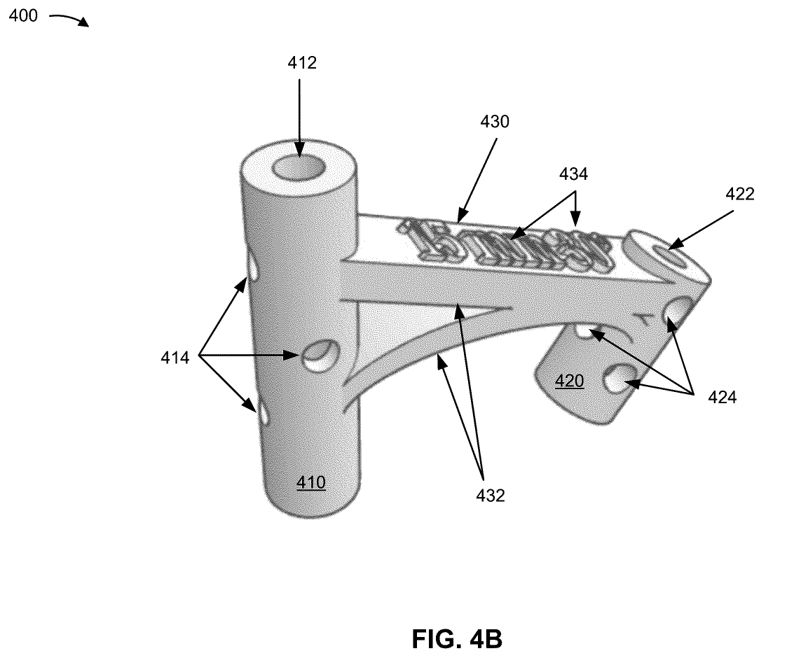

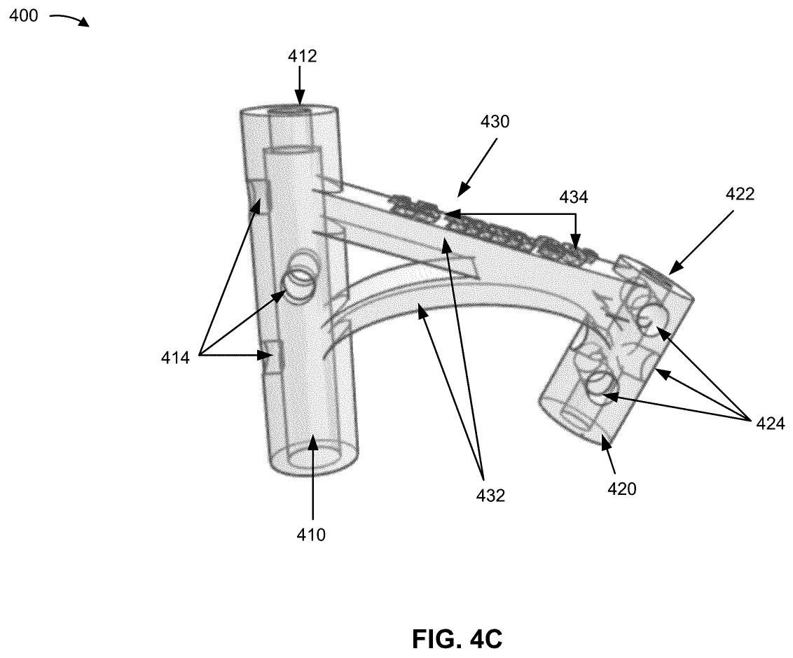

FIGS. 4A-4C are diagrams of a 30-degree angulation guide 400 according to one or more embodiments described herein. As shown in FIGS. 4A-4C, the 30-degree angulation guide 400 may comprise a guide pin sleeve 410, a drill guide sleeve 420, and a frame structure 430.

The guide pin sleeve 410 may comprise structure having a shape that is configured to receive at least a portion of a parallel guide pin (e.g., parallel guide pin 710 shown in FIG. 7A). For example, as shown in FIGS. 4A-4C, the parallel pin sleeve 410 may comprise a hollow cylinder forming a hole 412 that is configured to slide over the top of a parallel guide pin. In some implementations, a bottom surface of the pin sleeve 410 is configured to rest on a top surface of a dental implant, as shown in FIG. 8C.

In some implementations, the guide pin sleeve 410 may comprise a resin drain hole 414. In some implementations, as shown in FIGS. 4A-4C, the guide pin sleeve 410 may include a plurality of resin drill holes 414. In some implementations, the 30-degree angulation guide 400 may be generated using a 3D printing process and the resin drill hole(s) 414 may be configured to allow the resin to drain during the printing process. In some implementations, one or more of the plurality of resin drain holes 414 may be configured to allow for visualization of the parallel guide pin.

The drill guide sleeve 420 may comprise a structure having a shape that is configured to receive at least a portion of drill (e.g., a drill bit). For example, as shown in FIGS. 4A-4C, the drill guide sleeve 420 may comprise a hollow cylinder forming a drill guide hole 422. In some implementations, the drill guide hole 422 may be configured to receive the 1st and 2nd drills up to 2.0 mm for initial implant osteotomy. In some implementations, the drill guide hole 422 may be configured to accommodate a full guided case. In these implementations, a size of the drill guide sleeve 420 may be configured to receive drills greater than 2.0 mm.

In some implementations, the drill guide sleeve 420 may be configured to receive one or more other tools. For example, the drill guide sleeve 420 may be configured to receive a tissue punch used for uncovering a dental implant after healing.

In some implementations, a length of the drill guide sleeve 420 may be the same as a length of the guide pin sleeve 410. In some implementations, the length of the drill guide sleeve 420 may be different from the length of the guide pin sleeve 410. For example, the drill guide sleeve 420 may be longer or shorter than the guide pin sleeve 410.

In some implementations, the drill guide sleeve 420 may include a resin drain hole 424. In some implementations, as shown in FIGS. 4A-4C, the drill guide sleeve 420 may include a plurality of resin drill holes 424. In some implementations, the 30-degree angulation guide 400 may be generated using a 3D printing process and the resin drill hole(s) 424 may be configured to allow the resin to drain during the printing process. Additionally, or alternatively, the resin drain hole(s) 424 may be configured to allow water, blood, bone, and/or the like to drain during the initial osteotomy.

The frame structure 430 may be configured to couple drill guide sleeve 420 at a 30-degree angle with respect to the guide pin sleeve 210 and at a particular distance from the guide pin sleeve 210. In some implementations, the frame structure 430 may include one or more stabilization braces 432. In some implementations, as shown in FIGS. 4A-4C, the frame structure 430 includes two stabilization braces 432.

In some implementations, the frame structure 430 may include one or more identifiers 434. For example, the frame structure 430 may include an identifier 434 located on a surface of one or more stabilization braces 432. In some implementations, the frame structure 430 may include an identifier 434 indicating a length at which the 30-degree angulation guide 400 is configured to position a subsequent dental implant (e.g., 15 mm, as shown in FIG. 4B), an angle at which the 30-degree angulation guide 400 is configured (e.g., 30 degrees, as shown in FIG. 4B), and/or the like.

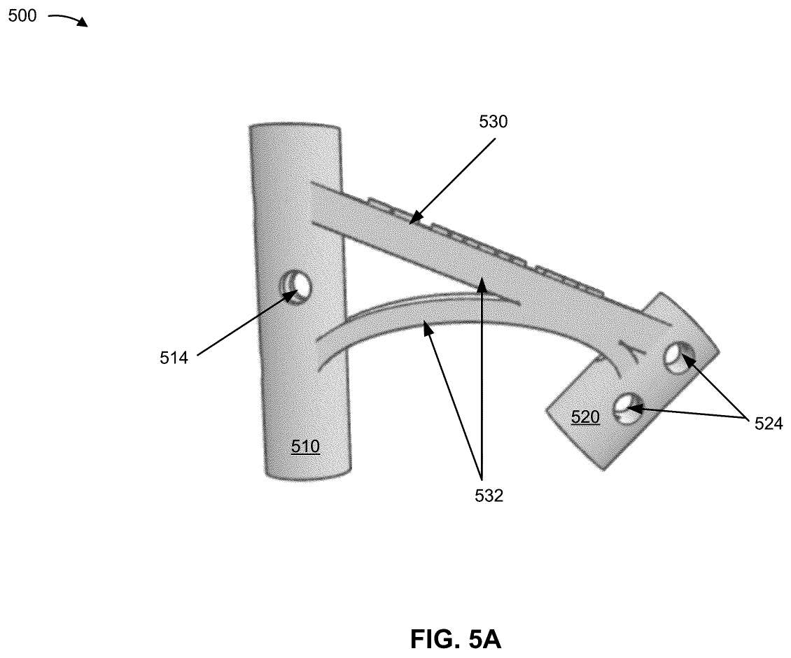

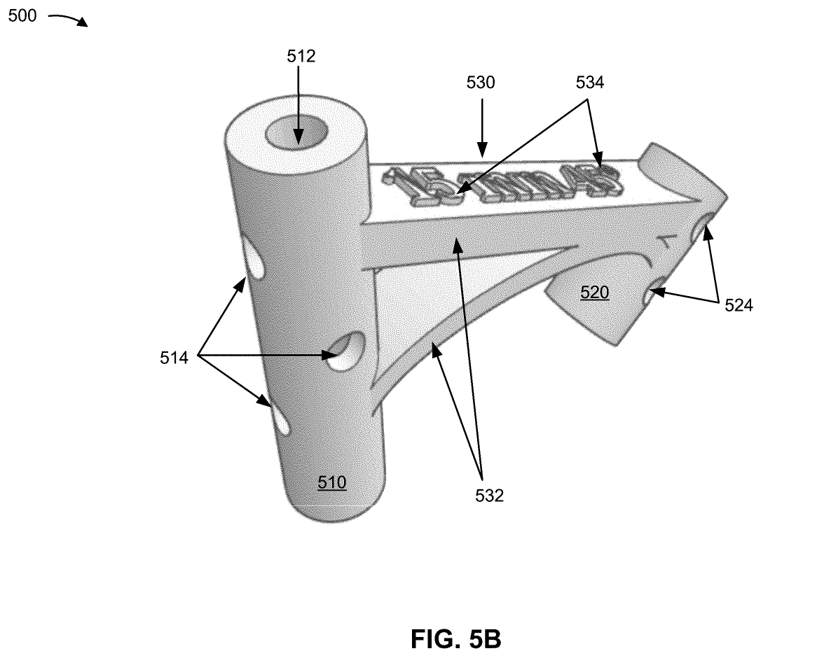

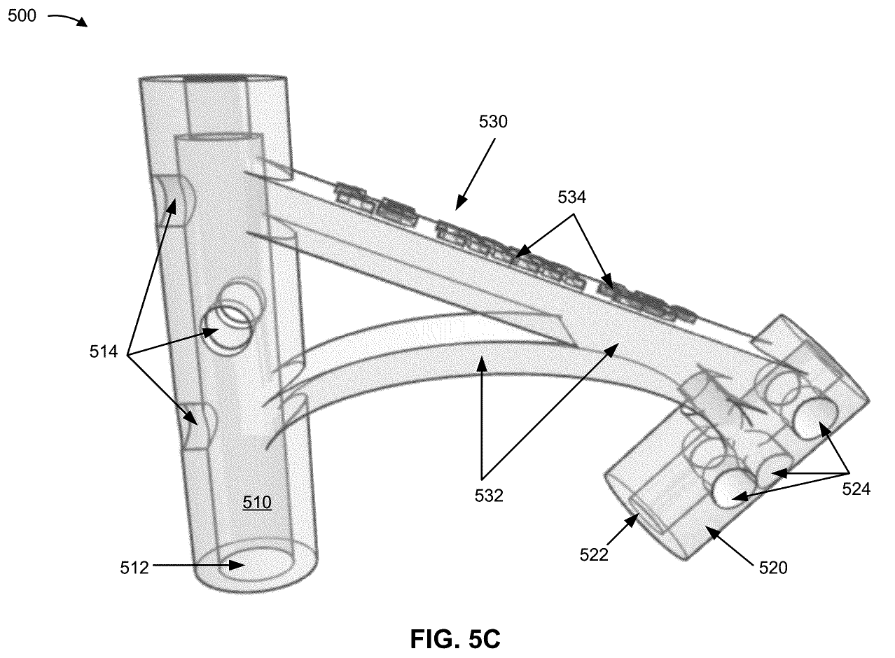

FIGS. 5A-5C are diagrams of a 45-degree angulation guide 500 according to one or more embodiments described herein. As shown in FIGS. 5A-5C, the 45-degree angulation guide 500 may comprise a guide pin sleeve 510, a drill guide sleeve 520, and a frame structure 530.

The guide pin sleeve 510 may comprise structure having a shape that is configured to receive at least a portion of a parallel guide pin (e.g., parallel guide pin 710 shown in FIG. 7A). For example, as shown in FIGS. 5A-5C, the parallel pin sleeve 510 may comprise a hollow cylinder forming a hole 512 that is configured to slide over the top of a parallel guide pin. In some implementations, a bottom surface of the pin sleeve 510 is configured to rest on a top surface of a dental implant, as shown in FIG. 8C.

In some implementations, the guide pin sleeve 510 may comprise a resin drain hole 514. In some implementations, as shown in FIGS. 5A-5C, the guide pin sleeve 510 may include a plurality of resin drill holes 514. In some implementations, the 45-degree angulation guide 500 may be generated using a 3D printing process and the resin drill hole(s) 514 may be configured to allow the resin to drain during the printing process. In some implementations, one or more of the plurality of resin drain holes 514 may be configured to allow for visualization of the parallel guide pin.

The drill guide sleeve 520 may comprise a structure having a shape that is configured to receive at least a portion of drill (e.g., a drill bit). For example, as shown in FIGS. 5A-5C, the drill guide sleeve 520 may comprise a hollow cylinder forming a drill guide hole 522. In some implementations, the drill guide hole 522 may be configured to receive the 1st and 2nd drills up to 2.0 mm for initial implant osteotomy. In some implementations, the drill guide hole 522 may be configured to accommodate a full guided case. In these implementations, a size of the drill guide sleeve 520 may be configured to receive drills greater than 2.0 mm.

In some implementations, the drill guide sleeve 520 may be configured to receive one or more other tools. For example, the drill guide sleeve 520 may be configured to receive a tissue punch used for uncovering a dental implant after healing.

In some implementations, a length of the drill guide sleeve 520 may be the same as a length of the guide pin sleeve 510. In some implementations, the length of the drill guide sleeve 520 may be different from the length of the guide pin sleeve 510. For example, the drill guide sleeve 520 may be longer or shorter than the guide pin sleeve 510.

In some implementations, the drill guide sleeve 520 may include a resin drain hole 524. In some implementations, as shown in FIGS. 5A-5C, the drill guide sleeve 520 may include a plurality of resin drill holes 524. In some implementations, the 45-degree angulation guide 500 may be generated using a 3D printing process and the resin drill hole(s) 524 may be configured to allow the resin to drain during the printing process. Additionally, or alternatively, the resin drain hole(s) 524 may be configured to allow water, blood, bone, and/or the like to drain during the initial osteotomy.

The frame structure 530 may be configured to couple drill guide sleeve 520 at a 45-degree angle with respect to the guide pin sleeve 510 and at a particular distance from the guide pin sleeve 510. In some implementations, the frame structure 530 may include one or more stabilization braces 532. In some implementations, as shown in FIGS. 5A-5C, the frame structure 530 includes two stabilization braces 532.

In some implementations, the frame structure 530 may include one or more identifiers 534. For example, the frame structure 530 may include an identifier 534 located on a surface of one or more stabilization braces 532. In some implementations, the frame structure 530 may include an identifier 534 indicating a length at which the 45-degree angulation guide 500 is configured to position a subsequent dental implant (e.g., 15 mm, as shown in FIG. 5B), an angle at which the 45-degree angulation guide 500 is configured (e.g., 45 degrees, as shown in FIG. 5B), and/or the like.

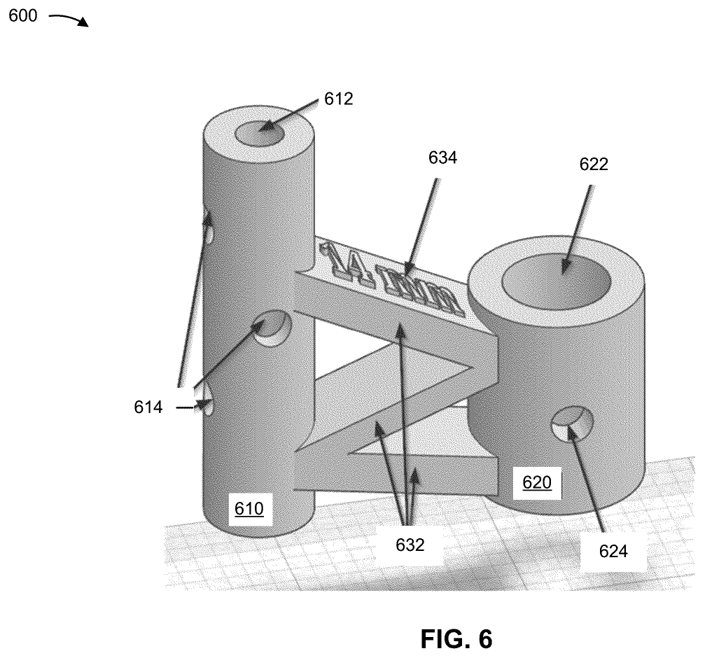

FIG. 6 is a diagram of a parallel uncover guide system 600 according to one or more embodiments described herein. The parallel uncover guide system 600 may be configured to enable a process for uncovering implants after a healing process has occurred. As shown in FIG. 6, the parallel uncover guide system 600 may comprise a parallel guide pin sleeve 610, a tissue punch sleeve 620, and a frame structure 630.

The parallel guide pin sleeve 610 may comprise structure having a shape that is configured to receive at least a portion of a parallel guide pin (e.g., parallel guide pin 710 shown in FIG. 7A). For example, as shown in FIG. 6, the parallel pin sleeve 610 may comprise a hollow cylinder forming a hole 612 that is configured to slide over the top of a parallel guide pin. In some implementations, a bottom surface of the parallel pin sleeve 610 is configured to rest on a top surface of a dental implant, as shown in FIG. 8C.

In some implementations, the tissue punch sleeve 620 may comprise a resin drain hole 614. to allow for the resin to drain when printing. In some implementations, the parallel uncover guide system 600 may comprise a plurality of resin drain holes 614. In some implementations, one or more of the plurality of resin drain holes 614 may be configured to allow for visualization of the parallel guide pin.

The tissue punch sleeve 620 may comprise a structure having a shape that is configured to receive a tissue punch used for uncovering a dental implant after healing. For example, as shown in FIG. 6, the tissue punch sleeve 620 may comprise a hollow cylinder forming a tissue punch hole 622. In some implementations, the tissue punch hole 622 may be larger than a drill guide hole (e.g., drill guide hole 112, drill guide hole 212, drill guide hole 312, drill guide hole 412, and/or drill guide hole 512). In some implementations, a size of the tissue punch sleeve 620 may be configured to such that a diameter of the tissue punch hole 622 is greater than 2.0 mm.

In some implementations, the tissue punch sleeve 620 may include a resin drain hole 624. In some implementations, the tissue punch sleeve 620 may include a plurality of resin drill holes 624. In some implementations, the parallel uncover guide system 600 may be generated using a 3D printing process and the resin drill hole(s) 624 may be configured to allow the resin to drain during the printing process. Additionally, or alternatively, the resin drain hole(s) 624 may be configured to allow water, blood, bone, and/or the like to drain during the process of uncovering the dental implant.

The frame structure 630 may be configured to couple the parallel guide pin sleeve 610 parallel to the tissue punch sleeve 620 and at a particular distance. In some implementations, the frame structure 630 may include one or more stabilization braces 632. In some implementations, as shown in FIG. 6, the frame structure 630 includes three stabilization braces 632. The use of three stabilization braces 632 may minimize or eliminate a rotation of the tissue punch sleeve 620.

In some implementations, the frame structure 630 may include one or more identifiers 634. For example, the frame structure 630 may include an identifier 634 located on a surface of one or more stabilization braces 632. In some implementations, the frame structure 630 may include an identifier 634 indicating a length at which the parallel uncover guide system 600 is configured to uncover dental implant at a particular distance from the parallel guide pin sleeve 610 (e.g., 14 mm, as shown in FIG. 6), an angle at which the parallel uncover guide system 600 is configured (e.g., parallel), and/or the like.

In some implementations, the parallel uncover guide system 600 may be configured to enable a tissue punch to uncover a dental implant placed using the parallel angulation guide 100 with minimal damage to the soft tissue. In some implementations, the parallel uncover guide system 600 may be configured to enable a tissue punch to uncover a dental implant placed using a different angulation guide. For example, the parallel uncover guide system 600 may comprise a 15-degree uncover guide system configured to enable a tissue punch to uncover a dental implant placed using the 15-degree angulation guide 200, a 17-degree uncover guide system configured to enable a tissue punch to uncover a dental implant placed using the 17-degree angulation guide 300, a 30-degree uncover guide system configured to enable a tissue punch to uncover a dental implant placed using the 30-degree angulation guide 400, and/or a 45-degree uncover guide system configured to enable a tissue punch to uncover a dental implant placed using the 45-degree angulation guide 500.

FIGS. 7A and 7B are diagrams of a parallel angulation guide 100 with example dental implants according to an implementation described herein.

As shown in FIG. 7A, a dental implant 705 may be coupled to a parallel guide pin 710. For example, the parallel guide pin 710 may include a set of threads (not shown) corresponding to a set of interior threads in a top portion of the dental implant body of the dental implant 705 and the parallel guide pin 710 may be screwed into the dental implant 705.

As shown in FIG. 7A, a parallel guide sleeve 110 of a parallel angulation guide 100 may be placed over the parallel guide pin 710. The initial osteotomy for a subsequent dental implant 715 may be started using a pilot drill through a drill guide hole 122 of a parallel drill guide sleeve 120. As shown in FIG. 7A, the parallel drill guide sleeve 120 may include a plurality of resin drain holes 124. The plurality of resin drain holes 124 may allow water and bone to drain from the parallel drill guide sleeve 120 during the initial osteotomy.

FIGS. 8A-8F are diagrams depicting a method 800 of utilizing a guide system according to an implementation described herein.

With reference now to FIG. 8A, a dental implant 805 may be placed in the bone of a patient. In some implementations, the dental implant 805 may be placed in the bone of the patient using a free hand technique as described above.

As shown in FIG. 8B, a parallel guide pin 810 may be coupled to the dental implant 805. For example, the parallel guide pin 810 may include a set of threads (not shown) corresponding to a set of interior threads in a top portion of the dental implant body of the dental implant 805 and the parallel guide pin 810 may be screwed into the dental implant 805.

As shown in FIGS. 8C and 8D, a parallel guide sleeve 110 of a parallel angulation guide 100 may be placed over the parallel guide pin 810. In some implementations, the parallel angulation guide 100 is one of a plurality of guides included in a guide system. A dental professional may determine a distance from the dental implant 805 (e.g., 10 mm, 15 mm, 17 mm, and/or the like) and an angle (e.g., parallel, 15 degrees, 17 degrees, 30 degrees, 45 degrees, and/or the like) at which a subsequent dental implant 815 (shown in FIG. 8E) is to be placed. The dental professional may select the parallel angulation guide 100 from the plurality of guides based on determining the distance and the angle.

In some implementations, the initial osteotomy for the subsequent dental implant 815 may be started based on placing the parallel guide sleeve 110 over the parallel guide pin 810. In some implementations, the initial osteotomy for the subsequent dental implant 815 may be started using a pilot drill through a drill guide hole 122 of a parallel drill guide sleeve 120. For example, a pilot drill may be inserted into the drill hole guide 122 and the dental professional may utilize the pilot drill to drill a depth suitable for placing the subsequent dental implant 815 into the bone of the patient.

As shown in FIGS. 8C and 8D, the parallel drill guide sleeve 120 may include a plurality of resin drain holes 124. The plurality of resin drain holes 124 may allow water and bone to drain from the parallel drill guide sleeve 120 during the initial osteotomy.

As shown in FIG. 8E, the subsequent dental implant 815 may be placed in the bone 820 of the patient based on the dental professional drilling to the depth suitable for placing the subsequent dental implant. In some implementations, the subsequent dental implant is placed using a freehand technique as described elsewhere herein. In some implementations, the dental professional may perform any remaining osteotomy drills needed based on a size of the subsequent dental implant 815. In some implementations, as shown in FIG. 8F, the parallel angulation guide 100 may be left in place to act as a stabilization and reference to the dental implant 805.

Although the guide system is described in the context of dental implants, the guide system may be utilized in any type of procedure requiring a uniform placement of a set of structures. For example, the guide system may be configured to guide the placement of a set of screws used in a procedure for setting a broken bone. In some cases, a support structure may be affixed across a break in a bone to facilitate the mending of the bone. To secure the support structure across the break, the guide may be configured to aid in the placement of a set of surgical screws in a uniform manner (e.g., at a same angle and/or a same distance from an end of the support structure and/or the break in the bone). For example, the guide may be placed across the break and then the drill guides could be broken away and the support structure left in place to secure the break. This type of guide may comprise a biocompatible material such as titanium, cobalt alloys, or surgical stainless steel.

As another example, the guide system may be configured to guide the placement of fence posts when building a fence. For example, after placement of an initial fence post, the guide may be configured such that the fence post extends through a hollow leg of the guide. A second hollow leg of the guide may be used to place a next fence post at a uniform distance from the initial fence post. For example, a marking device (e.g., paint, colored powder, etc.), an auger, drill, or similar type of tool can be utilize the second hollow leg of the guide to mark and/or drill a hole for placement of the next fence post.

The foregoing disclosure provides illustration and description, but is not intended to be exhaustive or to limit the implementations to the precise forms disclosed. Modifications and variations may be made in light of the above disclosure or may be acquired from practice of the implementations.

Even though particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiple of the same item.

No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A guide for placement of a dental implant, the guide comprising:
a guide pin sleeve configured to be inserted over a parallel guide pin;
a drill guide sleeve configured to receive at least a portion of a drill; and
a frame structure configured to couple the drill guide sleeve to the guide pin sleeve at a particular distance from the guide pin sleeve and at a particular angle with respect to the drill guide sleeve.

2. The guide of claim 1, wherein the guide pin sleeve comprises:
a drain hole configured to enable a user to view the parallel guide pin when guide pin sleeve is inserted over the parallel guide pin.

3. The guide of claim 1, wherein a bottom surface of the guide pin sleeve is configured to rest on a top surface of a dental implant.

4. The guide of claim 1, wherein the drill guide sleeve comprises:
one or more drain holes configured to allow a fluid or a bone to drain from the drill guide sleeve.

5. The guide of claim 1, wherein the drill guide sleeve comprises:
a drill guide hole.

6. The guide of claim 4, wherein the drill guide hole is configured to receive at least a portion of a tissue punch.

7. The guide of claim 1, wherein the frame structure comprises:
a stabilization brace.

8. The guide of claim 1, wherein the frame structure comprises:
three stabilization braces.

9. The guide of claim 1, wherein the frame structure is configured to prevent a rotation of the guide during an initial osteotomy.

10. A guide system comprising:
a first guide comprising:
a first guide pin sleeve configured to be inserted over a parallel guide pin,
a first drill guide sleeve configured to receive at least a portion of a drill, and
a first frame structure configured to couple the first drill guide sleeve to the first guide pin sleeve at a first distance from the first guide pin sleeve and at a first angle with respect to the first drill guide sleeve; and
a second guide comprising:
a second guide pin sleeve configured to be inserted over the parallel guide pin,
a second drill guide sleeve configured to receive at least the portion of the drill, and
a second frame structure configured to couple the second drill guide sleeve to the second guide pin sleeve at a second distance from the second guide pin sleeve and at a second angle with respect to the second drill guide sleeve.

11. The guide system of claim 10, wherein the first distance is different from the second distance.

12. The guide system of claim 10, wherein the first angle is different from the second angle.

13. The guide system of claim 12, wherein the first angle comprises:
0 degrees,
15 degrees,
17 degrees,
30 degrees, or
45 degrees.

14. The guide system of claim 10, wherein the first distance is the same as the second distance, and
wherein the first angle is different from the second angle.

15. The guide system of claim 10, wherein the first distance is different from the second distance, and
wherein the first angle is the same as the second angle.

16. The guide system of claim 10, wherein the first angle comprises:
0 degrees,
15 degrees,
17 degrees,
30 degrees, or
45 degrees.

17. The guide system of claim 10, further comprising:
a plurality of guides having respective lengths,
wherein the plurality of guides includes the first guide, the second guide, and at least one additional guide.

18. The guide system of claim 17, wherein the respective lengths of the plurality of guides range from 10 mm to 25 mm.

19. The guide system of claim 17, wherein the respective lengths increase in one or more increments.

20. The guide system of claim 19, wherein the one or more increments comprise one or more of:
a 0.5 mm increment, a 1.0 mm increment, or a 1.5 mm increment.
